(19) United States
(12) Patent Application Publication
(10) Pub. No.: US 2024/0193295 A1
(43) Pub. Date: Jun. 13, 2024

(54) Scalable Dataset Sharing With Linked Datasets

(71) Applicant: Google LLC, Mountain View, CA (US)

(72) Inventors: Thibaud Hottelier, Seattle, WA (US); Brian Lee Welcker, Seattle, WA (US); Jonah Tang Soon Yuen, Sunnyvale, CA (US); Neil Martin Devine, Santa Clara, CA (US)

(21) Appl. No.: 18/080,178

(22) Filed: Dec. 13, 2022

(51) Int. Cl. G06F 21/62; G06F 16/2458

(52) U.S. Cl. CPC G06F 21/6227; G06F 16/2471

(57) ABSTRACT

Aspects of the disclosure relate to managing access to published data by different groups of users through linked datasets. A subscriber system generates a linked dataset that links the subscriber system to a source dataset published by a publisher system. The subscriber system queries the linked dataset. Queries to the linked dataset are redirected to the source dataset. The subscriber system manages access control to the linked dataset instead of the publisher system managing access control for the subscriber system directly to the source dataset. The source dataset does not need to be copied to the subscriber system. From the perspective of the subscriber system, changes to the source dataset appear instantly, as subscribers may query the source dataset through the linked dataset without waiting for copies of the source dataset to propagate.

### BACKGROUND

A database management system (DBMS) is a system for managing databases and for receiving and resolving queries to the managed databases. A DBMS can manage datasets on devices storing the databases. A dataset is a container for database objects, such as tables, views, functions, stored procedures, etc. The DBMS can read and write to database objects. Reading and writing operations include updating, deleting, and adding data to the database objects.

Database objects may be protected using access control lists (ACLs). An ACL records users or groups of users with access to a database object, as well as the level of their access, e.g., read-only access, read- and update-access, read-, update-, and create-access, etc. An ACL can define access according to a hierarchy, such that access to a dataset or database object higher in the hierarchy extends access to datasets and database objects lower in the hierarchy. For example, a user to a database managed by the DBMS and with a particular access level to a dataset can inherit that same access for database objects within the dataset.

A DBMS uses an ACL to record the access level of a database or parts of the database for each user of a group, such as a network or organization of users. Protecting and managing access levels for a database is harder when multiple groups of users are involved, especially when each group is part of a different organization or distinct sub-group within an organization. Different organizations may wish to share data with predetermined limitations, but do not know each other's organizational structure, e.g., the types of roles users may have, the quantity of users, etc., to apply those limitations correctly. Different groups of users are also not necessarily aware of or entitled to know changes in the organizational structure of other groups. Further, a group responsible for managing the ACL may delay or make mistakes in updating the ACL relative to changes in the composition of another group accessing the database. This added complication results in a higher risk of database access mis-management, exposing the database to potential vulnerabilities, theft, and/or data corruption. These problems increase as the number of groups accessing the database increases.

### BRIEF SUMMARY

Aspects of the disclosure relate to a system for managing access to published data by different groups of users through linked datasets. A linked dataset is a collection of references to the database objects of a source dataset. A subscriber system generates a linked dataset that links the subscriber system to a source dataset published by a publisher system. To access data from the source dataset, the subscriber system queries the linked dataset. Queries to the linked dataset are redirected to the source dataset. The subscriber system manages access control to the linked dataset instead of the publisher system managing access control for the subscriber system directly to the source dataset. The source dataset does not need to be copied to the subscriber system. From the perspective of the subscriber system, changes to the source dataset may appear instantly, as subscribers may query the source dataset through the linked dataset without waiting for copies of the source dataset to propagate.

Aspects of the disclosure provide for a method including: receiving, by the one or more processors, a request from a device to access a source dataset maintained on one or more storage devices, and in response to the request: enabling, by the one or more processors, access to the source dataset by the device through a linked dataset, the linked dataset including a link to a database object of the source dataset, wherein queries for the database object are queried to the linked dataset and are redirected to the source dataset through the link, and providing, by the one or more processors, data from the database object in response to queries by the device to the linked dataset and redirected to the source dataset.

Other implementations of this aspect include corresponding computer systems, apparatus, and computer programs recorded one or more computer-readable storage media, each configured to perform the actions of the methods.

The foregoing and other implementations can each optionally include one or more of the following features, alone or in combination. One implementation includes all the following features in combination.

The enabled access is read-only access, and wherein in maintaining the source dataset the one or more processors are configured to accept changes to the source dataset only from the one or more processors.

The linked dataset links portions of the source dataset of which the device has access enabled; and wherein in enabling read-only access by the device to the source dataset, the one or more processors are configured to enable read-only access to the source dataset only to portions of the source dataset linked by the linked dataset.

The request is a first request, and wherein the one or more processors are further configured to: receive a second request to access the database object in the source dataset, and in response to the second request: determine that the second request was received through a named database object in the linked dataset referenced by the database object, and in response provide the database object in the source dataset.

The one or more processors are further configured to: receive an identifier for the database object; and translate the identifier using a data structure mapping a source identifier for the database object with one or more other identifiers for the database object maintained by devices each including a respective linked dataset corresponding to the source dataset.

The device is one of a plurality of devices, and wherein the one or more processors are further configured to: receive requests from the plurality of devices for accessing the source dataset, and for each request: determine whether the request is received through a respective linked dataset maintained by the device from which the request is received, and in response to the determination, process the request to determine the portion of the source dataset to provide to the requesting device.

The linked dataset includes one or more named database objects each named database object including a reference to a corresponding database object in the source dataset; and wherein in processing the request to determine the portion of the source dataset to provide to the requesting device the one or more processors are configured to provide read-only access to the database objects corresponding to the named database objects of the linked dataset.

An aspect of the disclosure is directed to a method, including sending, by one or more processors, a request from a device for access to a source dataset; receiving, by the one or more processors, an indication that access to the source dataset is enabled through a linked dataset, the linked dataset including a link to the source dataset; generating, by the one or more processors, the linked dataset; and querying, by the one or more processors, the linked dataset for data, and in response to the query, receive data from the source dataset.

Other implementations of this aspect include corresponding computer systems, apparatus, and computer programs recorded one or more computer-readable storage media, each configured to perform the actions of the methods.

The foregoing and other implementations can each optionally include one or more of the following features, alone or in combination. One implementation includes all the following features in combination.

The link is to a respective named database object in the linked dataset is referenced by a database object in the source dataset for which access has been enabled for the system.

The method further includes maintaining control access by one or more user accounts to the source dataset through access permissions on the linked dataset.

The source dataset is maintained in a data repository external to the system.

Queries to the linked dataset are redirected to the source dataset.

Access to the source dataset is read-only access; and wherein in generating the linked dataset, the one or more processors are configured to perform operations enabled for the source dataset except for modifying data in the source dataset.

### BRIEF DESCRIPTION OF THE DRAWINGS

FIG. 1 is a block diagram of an example publisher system exchanging data with an example subscriber system using a linked dataset, according to aspects of the disclosure.

FIG. 2A is an example data flow diagram for publishing a source dataset, according to aspects of the disclosure.

FIG. 2B is an example data flow diagram for subscribing to a source dataset and for generating a corresponding linked dataset, according to aspects of the disclosure.

FIG. 3 is a flow diagram of an example process for serving database objects in response to a request for data from a subscriber device.

FIG. 4 is a flow diagram of an example process for requesting database objects using a linked dataset.

FIG. 5 is a block diagram of an example computing environment including a publisher and a subscriber system, according to aspects of the disclosure.

### OVERVIEW

Aspects of the disclosure relate to a system for managing access by different groups of users to published data through linked datasets. A subscriber system, e.g., a collection of devices accessed by a group of users, generates a linked dataset for linking the subscriber system to a source dataset published by a publisher system. A source dataset is a dataset that a publisher system makes available for access by one or more subscriber systems. A linked dataset represents the source dataset but is stored in the subscriber system. Different linked datasets linking to the same source dataset can be stored in different subscriber systems at the same time. The linked dataset can support the same set of operations as the source dataset, except that the subscriber system cannot modify the contents of the source dataset. The subscriber system can read from the linked dataset using the same interface and commands that are used to interact with datasets native to the subscriber system. A native dataset is a dataset that is stored in storage devices that are part of a subject system, e.g., as opposed to storing the dataset in a different physical system or platform.

To access data from the source dataset, a subscriber system queries the linked dataset. Queries to the linked dataset are redirected to the source dataset. The subscriber system manages access control to the linked dataset instead of the publisher system managing access control for the subscriber system directly to the source dataset. Users of the linked dataset do not need direct access to or any information about the source dataset. The source dataset does not need to be copied from the publisher system to the subscriber system. From the perspective of the subscriber system, changes to the source dataset may appear instantly, as a subscriber system may query the source dataset through the linked dataset without waiting for copies of the source dataset to propagate.

Organizations, e.g., groups of users, businesses, enterprises, academic institutions, etc., often rely on data sharing among one another for performing their own data analysis and processing. Traditional data sharing, e.g., by copying data from a source to a destination, has several problems. Traditional data sharing is costly, at least because multiple copies of data are transmitted and stored. Data that is shared may be shared late or be out-of-date relative to changes in a source dataset. Several organizations may wish to share the same data, introducing additional challenges in managing correct data access control consistent with permissions granted for each system.

According to aspects of the disclosure, a subscriber system sends a request to subscribe to the source dataset and the publisher system responds with an indication that the subscriber system may query the source dataset by generating a linked dataset in the subscriber system. The publisher system can define parameters for delegating management of access control of a source dataset to the subscriber system. As creator of a linked dataset, the subscriber system can grant roles and permissions to users and groups of users to the linked dataset, without verification or approval from the publisher system. However, the subscriber system may not grant additional permissions to the source dataset beyond what was provided by the publisher system. For example, the subscriber system may not grant permission to modify the data in the source dataset.

Because the linked dataset links to the source dataset, changes to the source dataset by the publisher system can be available immediately to a subscriber system after the changes are completed. Access can be guided by various organizational principles or heuristics, such as the principle of least privilege, in which a user is granted access to the least amount of data to perform their function or role in an organization.

In some examples, aspects of the disclosure may be implemented as part of an analytics system. An analytics system can be configured to perform services related to data analysis and sharing of analytics and source datasets. Publisher systems may publish their source datasets for consumption by subscriber systems, using linked datasets as described here. Subscriber systems can use data provided through linked datasets for performing their own data analytics or data processing, without expensive copying or potential security vulnerabilities. Source datasets may be hosted on a common platform for efficient querying and retrieval, further mitigating the need for individual subscriber systems to implement infrastructure for storing and maintaining copies of the source dataset. The analytics system may provide features, such as the use of linked datasets for data sharing, using an interface, such as an API or web portal.

In one example, a publisher system can publish a dataset for use in training a machine learning model. Example types of data that may be published include network security data, forecasting data, aggregate statistics from different sources, etc. Subscriber systems may subscribe to the dataset, each generating a respective linked dataset for accessing the source dataset. Devices in a subscriber system may query a linked dataset to access data to be used for their own processing. Devices within a subscriber system may have different permissions for accessing data, managed using a database management system (DBMS) or another system with access control functionality. Because the target of the access control is the linked dataset, access control management and database query and retrieval are performed, from the perspective of a device of the subscriber system, in the same way a device may query and retrieve data from a dataset natively stored on the subscriber system.

A publisher system can implement a translation layer for transmitting data from a source dataset to a subscriber system. The translation layer may be hardware, software, and/or firmware configured to manage qualified names for source datasets and objects within the data. A dataset object may be referred to by different names for different subscriber systems. The translation layer maintains these names and other subscriber-specific information.

Aspects of the disclosure can provide for at least the following technical advantages. Data access control is managed by subscriber systems without the need to distribute access control lists (ACLs) or other control access data by the publisher system. In this way, potentially sensitive information about other groups of users of other different subscriber systems that have access to the data is withheld. Further, because roles can be updated or generated anew independently by the subscriber system generating the linked dataset, aspects of the disclosure can mitigate back-and-forth exchanges otherwise needed when publisher systems are responsible for approving data access control changes.

In addition, the need to generate and synchronize copies of ACLs can be avoided, which can reduce storage and bandwidth requirements otherwise needed to share data access control information to subscriber systems. Reducing or eliminating shared data can reduce the exposure to data leaks and other security risks. A DBMS implemented according to aspects of the disclosure can avoid the need for costly and error-prone synchronization mechanisms. A publisher system also deals with additional layers of security, e.g., virtual private clouds, firewalls, service controls that prevent unwanted network access, etc., implemented when publicly or semi-publicly data is made available. Implementing these security layers can be computationally less demanding. e.g., with fewer running subroutines to verify that ACLs are correctly managed and updated, when ACLs are managed by the subscriber systems through linked datasets.

Linked datasets and their implementation as described herein can also eliminate the need for an intermediary of shared resources. For example, a subscriber system can access a dataset directly, using a linked dataset, as opposed to accessing a separate but shared container. The shared container can have limitations as to how data may be manipulated, and by whom, in a way that accessing the dataset at its source does not have.

### Example Systems

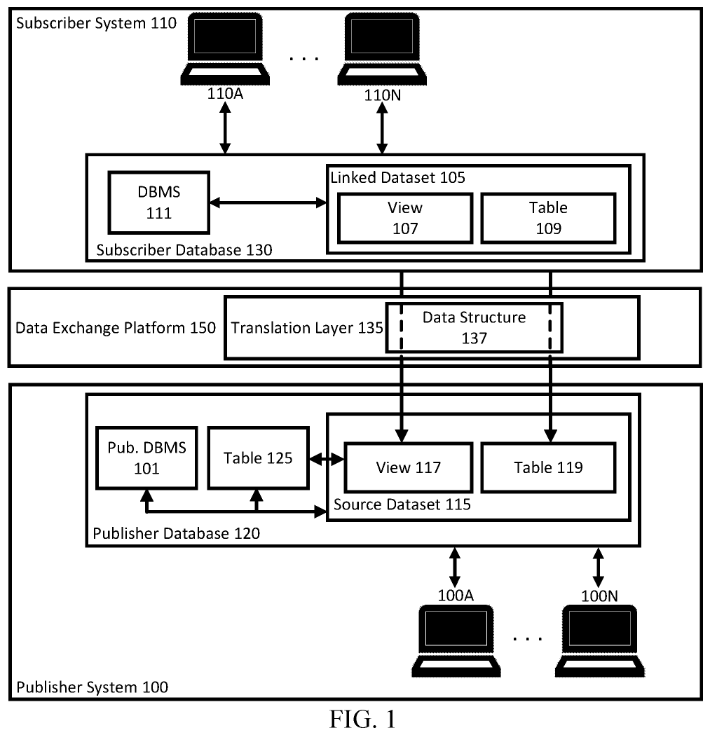

FIG. 1 is a block diagram of an example publisher system 100 exchanging data with an example subscriber system 110 using a linked dataset 105, according to aspects of the disclosure. A publisher or subscriber system can be one or more devices that are physically or logically connected. For example, a system can include one or more devices that are part of the same local network or housed in the same physical facility. In other examples, a system includes devices that are operated by one or more groups of users, which may collectively be referred to as an organization, business, institution, enterprise, etc.

In some examples, the subscriber system 110 may be vertically or horizontally related to the publisher system 100 along an organizational chart for a group of users. In one example, the publisher system 100 may be operated by a department of an organization responsible for generating or maintaining a source dataset 115 and the subscriber system 110 may be operated by another department in the organization that at least partially relies on the source dataset 115 for performing its function in the organization. In some examples, the subscriber system 110 is a subset of devices within the publisher system 100.

Local data and data from the linked dataset 105 may be combined or joined. The combinations or joins allow for devices in the system 110 to natively query and retrieve data from the linked dataset 105 whether the origin of the data is local or from the source dataset 115. The added or modified data to the linked dataset 105 does not modify the contents of the source dataset 115.

Although a single subscriber system 110 is shown as having generated a linked dataset 105 for the publisher system 100, in other examples, the subscriber system 110 may be subscribed to multiple publisher systems concurrently. The publisher system 100 may include user devices 100A through 100N that may be, for example, user terminals or personal devices, such as laptops, smartphones, desktop computers, tablets. The subscriber system 110 may include user devices 110A through 110N. The user devices 110A through 110N may include user terminals or personal devices. Publisher database 120 can be managed by a database management system (DBMS) 111 and be implemented on one or more devices of the publisher system 100. The one or more devices may be, for example, the one or more user devices 100A through 100N, or through other devices, such as servers. Subscriber database 130 can also include a DBMS 111.

The publisher and/or subscriber databases 130, 120 can include a variety of database objects and collections of database objects. Example database objects include datasets, tables, views, materialized views, models, e.g., machine learning models, dataset/table snapshots, etc. In general, any type of data that can be managed by a DBMS may form at least part of a database as described herein. The example publisher database 120 includes the source dataset 115 and a table 125. In FIG. 1, the source dataset 115 is published and is available for subscription, but not the table 125. The source dataset 115 includes a view 117 and a table 119. The subscriber database 130 includes the linked dataset 105, which includes a view 107 and a table 109. The view 107 can function as a reference to the view 117 and the table 109 can function as a reference to the table 119.

Although an example is given in which the source dataset 115 is published, any type of database object up to and including the database itself may be published and a corresponding database object created by the subscriber system 110, according to aspects of the disclosure. It is understood that in different examples, a system may be both a publisher and a subscriber system to different datasets. In addition, in different examples, a publisher system may publish a source dataset having multiple subscriber systems and be subscribed to source datasets of multiple publisher systems.

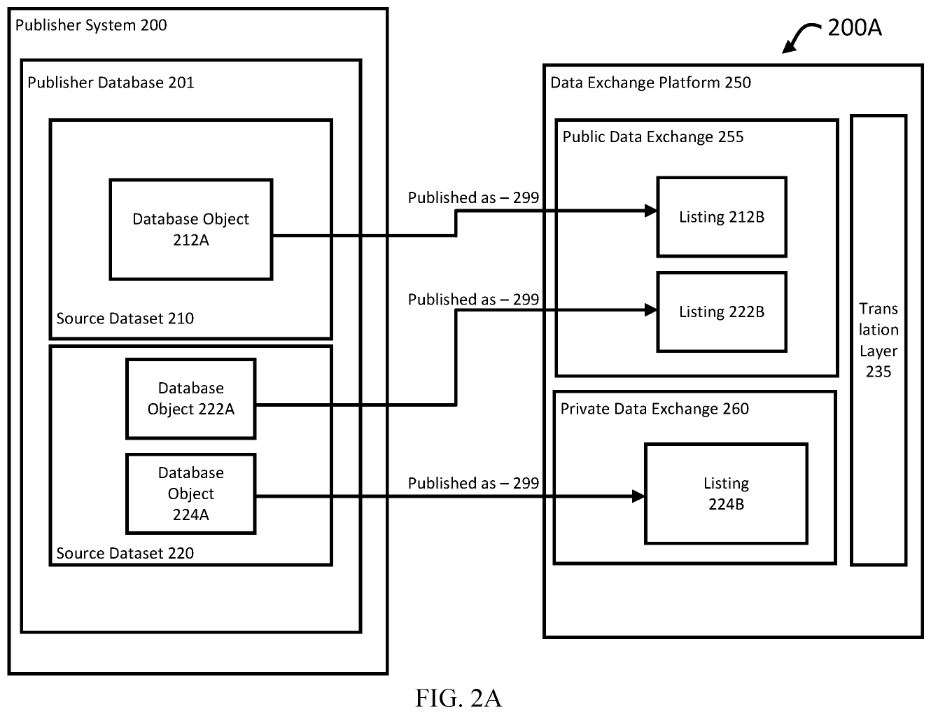

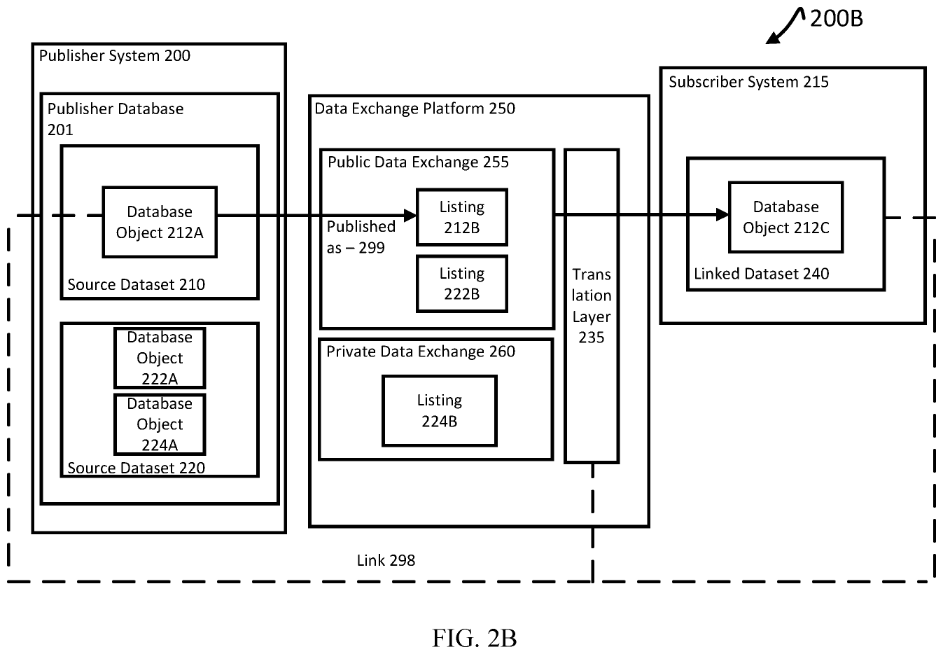

Subscriber system 110 and publisher system 100 may be communicatively coupled, for example over a network. In some examples, the publisher system 100 may make datasets available for subscription by indicating their availability to a website or computing platform, such as data exchange platform 150. Available datasets may be managed and be searchable through a web or API interface, for example allowing users of either a publisher or subscriber system to browse or search for available datasets. As described in more detail with respect to FIGS. 2A and 2B, information about available datasets can be contained in data structures referred to here as listings. The publisher system 100 can manage systems subscribed to a source dataset through its corresponding listing. Listings offered by the publisher system 100 can be further encapsulated in a data structure referred to as a data exchange, as described herein with reference to FIGS. 2A and 2B.

In one example of data retrieval, user device 110A sends a query to DBMS 111 for retrieving data from table 119. The query sent is not for table 119, however, but to the table 109. The DBMS 111 queries the linked dataset 105 and identifies table 109 as the corresponding reference for table 119 in the source dataset 115. As part of the identification, for example, the table 109 may have some metadata included for identifying the source dataset 115 and the specific database object referenced by the table 109. Because the table 109 is a reference and does not store the data from the table 119, the DBMS 111 queries the table 119 by passing the query through to the translation layer 135.

As shown in FIG. 1, the translation layer 135 can be implemented as part of the data exchange platform 150, described herein with reference to FIGS. 2A and 2B. The translation layer 135 can be any combination of hardware, firmware, and/or software. The translation layer 135 is configured to translate queries sent from the subscriber system 110 to corresponding source datasets published by the publisher system 100.

The translation layer 135 can maintain a data structure 137, e.g., a look-up table, of identifiers assigned to named database objects by the subscriber system 110. From the perspective of a querying device, e.g., device 110A, a query can reference an identifier for a named database object corresponding to the desired database object in the source dataset 115. For example, a query from device 110A may reference table 109 by a name or identifier, e.g., “employees.” The translation layer 135 can maintain a mapping of the identifier of the table 109 to the identifier for the table 119 in the source dataset 115. For multiple subscriber systems each with a respective linked dataset, the translation layer 135 can map multiple database object identifiers in the linked dataset 105 to an identifier of a database object in the source dataset 115.

The translation layer 135 can be configured to resolve internal references to source database objects accessed by the subscriber system 110. For example, view 117 may reference table 119 in the source dataset 115. The translation layer 135 captures this reference by translating the query to view 107 to a query for table 109. The query to table 109 is resolved as a query to table 119. This intermediate translation, e.g., view 117 to table 119 to table 109, captures access control defined by the subscriber system 110 when it is necessary to provide access to the references of a database object, in addition to the database object itself. Having this intermediate translation allows access control on the view 117 and its references to be enforced, from the perspective of the subscriber system 110.

The linked dataset 105 functions as a namespace for the contained objects, e.g. tables, views, and the translation layer 135 can resolve different identifiers for the same object using the namespace. For example, a source dataset 115 can be named “source_ds” while the linked dataset 105 is named “linked_ds” and table 109 is named “customers.” In the linked dataset 105, the table 109 may be identified as “linked_ds.customers,” while in the source dataset 115, the table 119 is identified as “source_ds.customers.” Within a query, the translation layer 135 resolves references to “linked_ds.customers” to “source_ds.customers”.

The translation layer 135 can also provide the parameters for which access to the source dataset 115 is permitted. For example, the subscriber system 110 has access to the view 117 and the table 119 of the source dataset 115. In some examples, the publisher system 100 may only publish subsets of a source dataset to some subscriber systems, but not others.

FIG. 2A is an example data flow diagram 200A for publishing a source dataset, according to aspects of the disclosure. Example publisher database 201 includes source datasets 210 and 220. Source dataset 210 includes database object 212A. Source dataset 220 includes database objects 222A and 224A. Publisher system 200 managing the publisher database 201 can offer database objects or entire datasets for subscription on a data exchange platform 250. In some examples, the data exchange platform 250 is part of the publisher system 200 alongside the publisher database 201. In other examples, the data exchange platform 250 can be a cloud platform, e.g., a third-party service provider offering the feature of source dataset access by subscribers through linked datasets as described herein. The data exchange platform 250 can implement a translation layer 235 for translating queries between systems, e.g., as described with reference to FIG. 1 and the translation layer 135.

The data exchange platform 250 may receive requests through user devices to publish, search for, and/or subscribe to datasets on the platform 250. These user devices may include devices that collectively form part of a publisher or subscriber system. Different user devices may be assigned different roles on the platform 250. User devices assigned to certain roles may be permitted to act on behalf of their respective system. For example, a user device may be a publisher device, with the ability to publish datasets from its respective system to the data exchange platform 250. As another example, a user device may be a subscriber device, with the ability to subscribe to datasets on behalf of its respective system. In addition to subscribers and publishers, the data exchange platform 250 may define other roles, such as viewer devices that may view but not subscribe to a source dataset. An administrator device is an example of a device with another type of defined role that may manage multiple source datasets. These multiple source datasets may be potentially published by different publisher systems.

A data exchange is a data structure configured to enable data sharing on the platform 250. A data exchange can include listings, which reference source datasets. In FIG. 2A, publisher system 200 has two data exchanges published on the data exchange platform 250: public data exchange 255 and private data exchange 260. Data exchanges may include metadata describing the offered dataset, which can be used on the platform 250 to facilitate searching and browsing. To avoid granting access on the source datasets explicitly, the data exchange platform 250 can allow publisher systems to grant access for subscriber systems through the added layer of data exchanges and listings. In some examples, the platform 250 may not implement data exchanges, and instead facilitate communication directly between publisher and subscriber systems or use some other form of abstraction.

A listing is a reference to a source dataset that a publisher device or system stores in a data exchange. The publisher system 200 can create a listing and specify, for example, the source dataset description, the scope of data offered for subscription, and example queries that may be performed on the dataset and the types of data that may be returned. Other example data that may be specified in a listing include links to documentation or other information describing the dataset, and/or any additional information that can help users of a subscriber system to use the dataset.

Public data exchange 255 includes listings 212B and 222B, referencing database objects 212A and 222A, respectively. The arrows 299 indicate that a database object is published as a corresponding listing. A public data exchange is a data exchange that the publisher system 200 makes discoverable and available for subscription by devices or systems through the data exchange platform 250. Private data exchange 260 includes listing 224B referencing database object 224A. A private data exchange is private to systems or devices specified by the publisher system 200. The creation and configuration of data exchanges and/or listings can be performed by an appropriately configured translation layer, e.g., the translation layer 235 or other component of the publisher system 200. In some examples, a listing may be made public or private. Some listings may be made private within a public data exchange.

As described with reference to FIG. 2B, a subscriber system can subscribe to a source dataset through its listing to generate a linked dataset. In some examples in which data exchanges are implemented, data exchanges may not vary between public and private visibility. The use of data exchanges and listings facilitates a more granular level of control by the publisher system 200 for determining what data is to be made available for subscription to specified devices.

FIG. 2B is an example data flow diagram 200B for subscribing to a source dataset and for generating a corresponding linked dataset, according to aspects of the disclosure. Example subscriber system 215 accesses the data exchange platform 250, which includes the public data exchange 255 and the private data exchange 260. In this example, the subscriber system 215 does not have permission to view the private data exchange 260, which includes listing 224B. Instead, the subscriber system 215 can view the listings 212B and 222B, which can include metadata describing respective database objects of a published source dataset.

The subscriber system 215 is configured to generate linked dataset 240. The linked dataset 240 may be a read-only dataset that serves as a symbolic link to source dataset 210. Although a symbolic link is described with reference to FIG. 2B, it is understood that the linked dataset 240 can be or include any link to the source dataset 210, to enable access of data in the source data 210 through the linked dataset 240. Within the linked dataset, named database object 212C can be a reference to database object 212A, shown as link 298. Subscribing to listing 212B creates a linked dataset 240. The subscriber system 215 may read the data in database object 212A but may not write or otherwise modify data in the database object 212A. The subscriber system 215 may download and edit the data from database object 212A, but the changes would be local to the subscriber system 215.

When the subscriber system 215 queries named database object 212C, the query is translated and sent by the translation layer 235 to the database object 212A, through the link 298. Parameters for enabling access to the database object 212A can be specified in the listing 212B. The subscriber system 215 with linked dataset 240 accesses tables and views of the source dataset 210 without additional identity and control access authorization.

### Example Methods

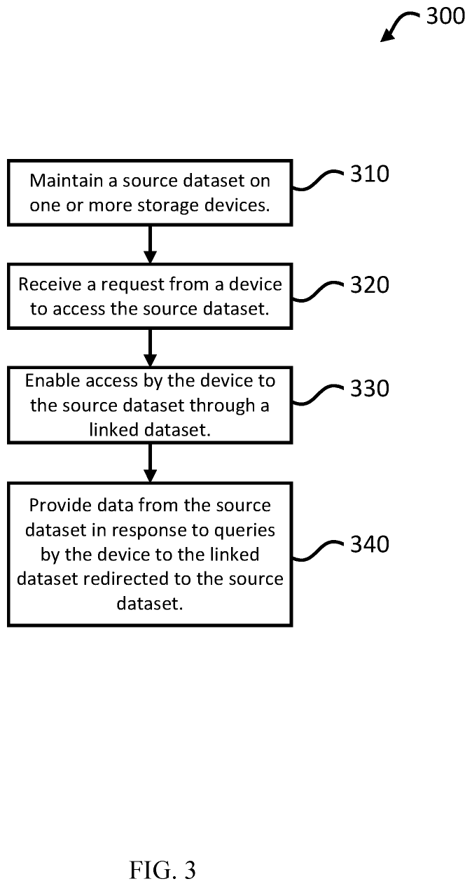

FIG. 3 is a flow diagram of an example process 300 for serving database objects in response to a request for data from a subscriber device. The example processes 300 and 400 described herein may be performed by a device or system including one or more processors. In some examples, processes described in this specification, including processes 300 and 400, may be performed by the publisher system 100 described herein with reference to FIG. 1. Although some steps of the processes 300 and 400 are described as being performed in a particular order, in some examples different steps may be added, removed, modified and/or be performed in parallel or sequentially. Further, although reference is made to a single publisher system and a single subscriber system, it is understood that the processes 300 and 400 can be repeated multiple times for multiple publisher systems and subscriber systems, including data exchange platforms operating as a publisher system.

A publisher system maintains a source dataset on one or more storage devices, according to block 310. The one or more storage devices may be, for example, part of a publisher system. The source dataset may be maintained in a data repository external to the system, e.g., in a data lake or datacenter.

The publisher system receives a request from a device to access the source dataset, according to block 320. The request can be from a subscriber system or be received from a data exchange platform on behalf of a subscriber system. The request can be generated through interaction with the subscriber system or a data exchange platform, for example on platforms 150 or 250 as described herein with reference to FIGS. 1, 2A, and 2B. In some examples, the data exchange platform can also be the publisher system.

The publisher system enables access by the device to the source dataset through a linked dataset, according to block 330. The access can be read-only access. When access is read-only, changes to the data in the source dataset may only be changed by the publisher system. When access is enabled, the subscriber system can generate a linked dataset for querying the source dataset. The publisher system can specify the types of operations or database objects of the source dataset to which the subscriber system will have access. The linked dataset generated can include respective named database objects for each database object of which the subscriber system has access. When enabling read-only access, only database objects queried through a respective named database object in a linked dataset are accessed.

A linked dataset may include one or more named database objects, each named database object including a respective reference to a corresponding database object in the source dataset. In processing the request to determine the portion of the source dataset to provide to the requesting device, the publisher system can be configured to provide read-only access to the database objects corresponding to the named database objects of the linked dataset.

The system provides data from the source dataset in response to queries by the device to the linked dataset redirected to the source dataset, according to block 340. Before redirecting to the actual source dataset, the publisher system can determine whether the named database object from which a query is received references a database object in the source dataset. If so, the query is redirected to the requested database object and data is returned to the requesting device in response to the query.

As described herein, linked datasets may have different identifiers for database objects in the source dataset. As part of serving the redirected query with the correct data, the translation layer maps the identifier in the query, e.g., how the subscriber system references the data, to a source database object identifier, e.g., how the publisher system references the same data, within the context of the query.

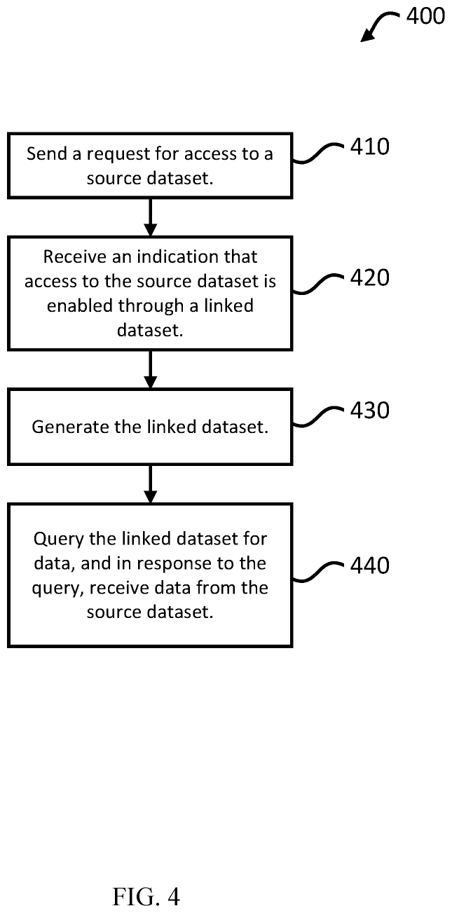

FIG. 4 is a flow diagram of an example process 400 for requesting database objects using a linked dataset. A subscriber system sends a request for access to a source dataset, according to block 410. In some examples, the subscriber system can view a listing on a data exchange platform describing the source dataset.

The subscriber system receives an indication that access to the source dataset is enabled through a linked dataset, according to block 420. The publisher system publishing the source dataset enables access to the source dataset and may send parameters for accessing the source dataset, e.g., what database objects in the source database are available for viewing or reading by the subscriber system.

The subscriber system generates the linked dataset, according to block 430. The linked dataset includes a named database object referencing the database object in the source dataset for which access has been enabled for the subscriber system. In some examples, access to the source dataset may be read-only access. In generating the linked dataset, the subscriber system may be configured to perform operations enabled for the source dataset, except for modifying data in the source dataset. The system can maintain control access by one or more user accounts to the source dataset through access permissions on the linked dataset.

The subscriber system queries the linked dataset for data, and in response to the query, receives data from the source dataset, according to block 440. Queries to the linked dataset are redirected to the source dataset. From the perspective of the subscriber system, devices in the subscriber system query the linked dataset as if it were the source dataset.

### Example Computing Environment

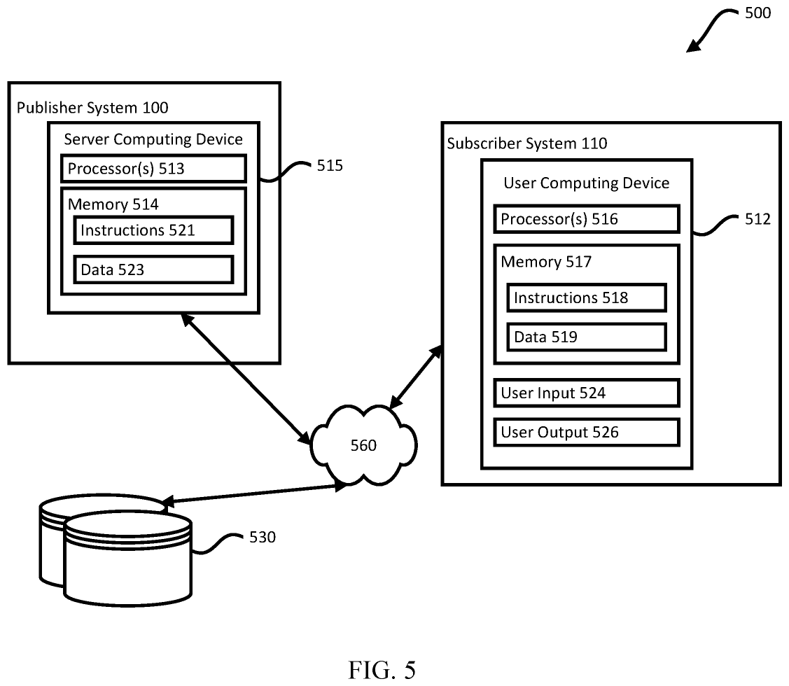

FIG. 5 is a block diagram of an example computing environment including a publisher system 100 and a subscriber system 110, according to aspects of the disclosure. The publisher system 100 and subscriber system 110 can be implemented on one or more devices having one or more processors in one or more locations, such as in server computing device 515. User computing device 512 and the server computing device 515 can be communicatively coupled to one or more storage devices 530 over a network 560. The storage device(s) 530 can be a combination of volatile and non-volatile memory and can be at the same or different physical positions than the computing devices 512, 515. For example, the storage device(s) 530 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 515 can include one or more processors 513 and memory 514. The memory 514 can store information accessible by the processor(s) 513, including instructions 521 that can be executed by the processor(s) 513. The memory 514 can also include data 523 that can be retrieved, manipulated, or stored by the processor(s) 513. The memory 514 can be a type of non-transitory computer readable medium capable of storing information accessible by the processor(s) 513, such as volatile and non-volatile memory. The processor(s) 513 can include one or more central processing units (CPUs), graphic processing units (GPUs), field-programmable gate arrays (FPGAs), and/or application-specific integrated circuits (ASICs), such as tensor processing units (TPUs).

The instructions 521 can include one or more instructions that when executed by the processor(s) 513, causes the one or more processors to perform actions defined by the instructions. The instructions 521 can be stored in object code format for direct processing by the processor(s) 513, or in other formats including interpretable scripts or collections of independent source code modules that are interpreted on demand or compiled in advance. The instructions 521 can include instructions for implementing the publisher system 100 and/or the data exchange platform 150 consistent with aspects of this disclosure. The publisher system 100 and/or the data exchange platform 150 can be executed using the processor(s) 513, and/or using other processors remotely located from the server computing device 515.

The data 523 can be retrieved, stored, or modified by the processor(s) 513 in accordance with the instructions 521. The data 523 can be stored in computer registers, in a relational or non-relational database as a table having a plurality of different fields and records, or as JSON, YAML, proto, or XML documents. The data 523 can also be formatted in a computer-readable format such as, but not limited to, binary values, ASCII, or Unicode. Moreover, the data 523 can include information sufficient to identify relevant information, such as numbers, descriptive text, proprietary codes, pointers, references to data stored in other memories, including other network locations, or information that is used by a function to calculate relevant data.

The user computing device 512 can also be configured like the server computing device 515, with one or more processors 516, memory 517, instructions 518, and data 519. The user computing device 512 can also include a user output 526, and a user input 524. The user input 524 can include any appropriate mechanism or technique for receiving input from a user, such as keyboard, mouse, mechanical actuators, soft actuators, touchscreens, microphones, and sensors. The user computing device 512 can be part of or implement the subscriber system 110, which may include one or more other devices.

The server computing device 515 can be configured to transmit data to the user computing device 512, and the user computing device 512 can be configured to display at least a portion of the received data on a display implemented as part of the user output 526. The user output 526 can also be used for displaying an interface between the user computing device 512 and the server computing device 515. The user output 526 can alternatively or additionally include one or more speakers, transducers or other audio outputs, a haptic interface or other tactile feedback that provides non-visual and non-audible information to the user of the user computing device 512.

Although FIG. 5 illustrates the processors 513, 516 and the memories 514, 517 as being within the computing devices 515, 512, components described in this specification, including the processors 513, 516 and the memories 514, 517 can include multiple processors and memories that can operate in different physical positions and not within the same computing device. For example, some of the instructions 521, 518 and the data 523, 519 can be stored on a removable SD card and others within a read-only computer chip. Some or all the instructions and data can be stored in a position physically remote from, yet still accessible by, the processors 513, 516. Similarly, the processors 513, 516 can include a collection of processors that can perform concurrent and/or sequential operation. The computing devices 515, 512 can each include one or more internal clocks providing timing information, which can be used for time measurement for operations and programs run by the computing devices 515, 512.

The server computing device 515 can be configured to receive requests to process data from the user computing device 512. For example, the environment 500 can be part of a computing platform configured to provide a variety of services to users, through various user interfaces and/or APIs exposing the platform services.

The devices 512, 515 can be capable of direct and indirect communication over the network 560. The devices 515, 512 can set up listening sockets that may accept an initiating connection for sending and receiving information. The network 560 itself can include various configurations and protocols including the Internet, World Wide Web, intranets, virtual private networks, wide area networks, local networks, and private networks using communication protocols proprietary to one or more companies. The network 560 can support a variety of short- and long-range connections. The short- and long-range connections may be made over different bandwidths, such as 2.402 GHZ to 2.480 GHZ (commonly associated with the Bluetooth® standard), 2.4 GHz and 5 GHZ (commonly associated with the Wi-Fi® communication protocol); or with a variety of communication standards, such as the LTE® standard for wireless broadband communication. The network 560, in addition or alternatively, can also support wired connections between the devices 512, 515, including over several types of Ethernet connection.

Although a single server computing device 515 and user computing device 512, are shown in FIG. 5, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

Unless otherwise stated, the foregoing alternative examples are not mutually exclusive but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including,” and the like, should not be interpreted as limiting the subject matter of the claims to the specific examples; rather, the examples are intended to illustrate only one of many possible implementations. Further, the same reference numbers in different drawings can identify the same or similar elements.

1. A system comprising one or more processors, the one or more processors configured to:
receive a request from a device to access a source dataset maintained on one or more storage devices, and in response to the request:
enable access by the device to the source dataset through a linked dataset, the linked dataset comprising a link to the source dataset, wherein queries to database objects in the source dataset are queried to the linked dataset and are redirected to the source dataset through the link, and
provide data from the database object in response to queries by the device to the linked dataset and redirected to the source dataset.

2. The system of claim 1, wherein the enabled access is read-only access, and wherein in maintaining the source dataset the one or more processors are configured to accept changes to the source dataset only from the one or more processors.

3. The system of claim 2,
wherein the linked dataset links portions of the source dataset of which the device has access enabled; and
wherein in enabling read-only access by the device to the source dataset, the one or more processors are configured to enable read-only access to the source dataset only to portions of the source dataset linked by the linked dataset.

4. The system of claim 1, wherein the request is a first request, and wherein the one or more processors are further configured to:
receive a second request to access the database object in the source dataset, and in response to the second request:
determine that the second request was received through a named database object in the linked dataset referenced by the database object, and in response provide the database object in the source dataset.

5. The system of claim 4, wherein the one or more processors are further configured to:
receive an identifier for the database object; and
translate the identifier using a data structure mapping a source identifier for the database object with one or more other identifiers for the database object maintained by devices each comprising a respective linked dataset corresponding to the source dataset.

6. The system of claim 1,
wherein the device is one of a plurality of devices, and wherein the one or more processors are further configured to:
receive requests from the plurality of devices for accessing the source dataset, and for each request:
determine whether the request is received through a respective linked dataset maintained by the device from which the request is received, and
in response to the determination, process the request to determine a portion of the source dataset to provide to the requesting device.

7. The system of claim 6,
wherein a linked dataset comprises one or more named database objects, each named database object comprising a reference to a corresponding database object in the source dataset; and
wherein in processing the request to determine the portion of the source dataset to provide to the requesting device the one or more processors are configured to provide read-only access to the database objects corresponding to the named database objects of the linked dataset.

8. A method comprising:
receiving, by one or more processors, a request from a device to access a source dataset maintained on one or more source devices, and in response to the request:
enabling, by the one or more processors, access to the source dataset by the device through a linked dataset, the linked dataset comprising a link to a database object of the source dataset, wherein queries for the database object are queried to the linked dataset and are redirected to the source dataset through the link, and
providing, by the one or more processors, data from the database object in response to queries by the device to the linked dataset and redirected to the source dataset.

9. The method of claim 8, wherein the enabled access is read-only access, and wherein maintaining the source dataset comprises accepting changes to the source dataset only from the one or more processors.

10. The method of claim 9,
wherein the linked dataset links portions of the source dataset of which the device has accessed enabled; and
wherein enabling read-only access by the device to the source dataset comprises enabling read-only access to the source dataset only to portions of the source dataset linked by the linked dataset.

11. The method of claim 8, wherein the request is a first request, and wherein the method further comprises:
receiving, by the one or more processors, a second request to access the dataset object, and in response to the second request:
determining that the second request was received through a named database object in the linked dataset corresponding to the database object, and in response providing, by the one or more processors, access to the database object in the source dataset.

12. The method of claim 11, the method further comprising:
receiving, by the one or more processors, an identifier for the database object; and
translating the identifier, by the one or more processors and using a data structure mapping a source identifier for the database object with one or more other identifiers for the database object maintained by devices each comprising a respective linked dataset corresponding to the source dataset.

13. The method of claim 8,
wherein the device is one of a plurality of devices, and wherein the method further comprises:
receiving, by the one or more processors and from the plurality of devices, requests for accessing the dataset, and for each request:
determining, by the one or more processors, whether the request is received through a respective linked dataset maintained by the device from which the request is received, and
in response to the determination, processing the request to determine a portion of the source dataset to provide to the requesting device.

14. The method of claim 13,
wherein a linked dataset comprises one or more named database objects, each named database object comprising a respective link to a corresponding database object in the source dataset; and
wherein processing the request to determine the portion of the source dataset to provide to the requesting device comprises providing read-only access to the database objects corresponding to the named database objects of the linked dataset.

15. A system comprising one or more processors, the one or more processors configured to:
send a request for access to a source dataset;
receive an indication that access to the source dataset is enabled through a linked dataset, the linked dataset comprising a link to the source dataset;
generate the linked dataset; and
query the linked dataset for data, and in response to the query, receive data from the source dataset.

16. The system of claim 15, wherein a respective named database object in the linked dataset is referenced by a database object in the source dataset for which access has been enabled for the system.

17. The system of claim 15, wherein the one or more processors are further configured to:
maintain control access by one or more user accounts to the source dataset through access permissions on the linked dataset.

18. The system of claim 15, wherein the source dataset is maintained in a data repository external to the system.

19. The system of claim 15, wherein queries to the linked dataset are redirected to the source dataset.

20. The system of claim 15,
wherein access to the source dataset is read-only access; and
wherein in generating the linked dataset, the one or more processors are configured to perform operations enabled for the source dataset except for modifying data in the source dataset.
